(19) United States
(12) Patent Application Publication
(10) Pub. No.: US 2016/0050862 A1
(43) Pub. Date: Feb. 25, 2016

(54) CONTROL SYSTEM FOR A HYDROPONIC GREENHOUSE GROWING ENVIRONMENT

(71) Applicant: Got Produce? Franchising, Inc., San Francisco, CA (US)

(72) Inventor: Deborah L. Walliser, Santa Cruz, CA (US)

(21) Appl. No.: 14/930,622

(22) Filed: Nov. 2, 2015

Related U.S. Application Data
(63) Continuation-in-part of application No. 13/662,134, filed on Oct. 26, 2012, now Pat. No. 9,220,206.
(60) Provisional application No. 62/073,902, filed on Oct. 31, 2014.
(60) Provisional application No. 61/551,431, filed on Oct. 26, 2011.

(51) Int. Cl. A01G 31/02

(52) U.S. Cl. CPC A01G 31/02

(57) ABSTRACT

A greenhouse growing environment has a distributed control system for selecting, monitoring, and administering hydroponic nutrient solution mixtures that are tailored to crop varieties of the greenhouse. The crop varieties are preselected based on location characteristics of the greenhouse and analysis results of source water. The analysis results indicate a nutrient composition of the source water. A predefined nutrient formulation is then automatically combined with the source water by a nutrient dispensing subsystem, to achieve a desired nutrient solution mixture that is applied to a hydroponic bay. A computational system automatically monitors the state of a hydroponic environment and directs input modules as programmed, in order to increase plant growth, plant quality, and volume of plant yield.

### RELATED APPLICATIONS

This application claims priority benefit of U.S. Provisional Patent Application No. 62/073,902, filed Oct. 31, 2014, and is a continuation-in-part of U.S. patent application Ser. No. 13/662,134, filed Oct. 26, 2012, which claims priority benefit of U.S. Provisional Patent Application No. 61/551,431, filed Oct. 26, 2011. Each aforementioned application is incorporated by reference herein.

### TECHNICAL FIELD

The present disclosure relates to hydroponic agriculture. More particularly, the present disclosure relates to control of hydroponic greenhouse growing environments.

### BACKGROUND INFORMATION

Hydroponic technology is being increasingly deployed for growing food and medicinal crops. Improvements in crop yield per unit of resource expended in hydroponic settings can generate significant benefits to many agricultural operations and thereby address society's increasing needs for resource-efficient agriculture.

### SUMMARY OF THE DISCLOSURE

When planning a hydroponic greenhouse installation, hydroponic greenhouse scientists consider greenhouse site characteristics, including the direction and duration of sun exposure, humidity and other climate factors, site area and terrain, and source water nutrient composition. These experts are also typically well versed in assessing the tradeoffs between using various growing environment technologies, such as nutrient film technique (NFT) or deep flow, and greenhouse growing environment configurations in connection with the selection of grow zones and bays within zones, grow mediums, and hydroponic nutrient administering and monitoring techniques. Furthermore, skilled greenhouse operators understand the market demand for various crops, and may manually monitor hydroponic solutions to intermittently compute complex nutrient concentration adjustments preparatory to applying the solution to their crops. Also, during operation, each plant variety has gardening nuances such as a specific number of leaves allowed on the plant, or number of fruits allowed on the plant for any given week. These growing traits have traditionally been available to only those greenhouses having direct access to highly experienced growers.

The aforementioned domain expertise presents a steep learning curve for less skilled persons seeking to deploy and maintain a successful commercial-scale hydroponic facility. This disclosure, therefore, describes technologies that flatten the learning curve so that hydroponic greenhouses can be preprogrammed, automated, and remotely monitored by experts, and then managed at the site by gardener staff persons with little or no hydroponic domain expertise.

A control system for hydroponic greenhouse growing environments includes a main (onsite) controller; multiple sensor-control modules (SCMs) operatively coupled to the main controller; and a remotely located central server to communicate with the main controller and thereby remotely monitor the multiple SCMs. In some embodiments, a tablet computer is configured to communicate with the main controller for monitoring, calibrating, and testing the control system, and receiving local system notifications.

The distillation of hydroponic domain expertise into the aforementioned preconfigured greenhouse system has additional advantages that are also discussed in this disclosure.

The greenhouse system of the present disclosure is designed to use both internal pond and vining systems. The pond system provides thermal stability in the greenhouse growing environment and thereby reduces temperature control expenditures. Likewise, the vining system controls mix tanks in fluid communication with high-precision nutrient delivery pumping equipment activated based on light sensors detecting a predetermined amount of measured sunlight. Precisely controlled and preprogrammed amounts of nutrients are thereby mixed into hydroponic solutions and applied to preselected crop varieties based on a detected threshold amount of sunlight, according to predefined crop recipes specially developed by offsite hydroponics experts.

Because the greenhouse may be located in a location subject to sporadic internet connectivity, the preprogrammed information and sensor data that control the greenhouse growing environment are intermittently synchronized (i.e., cached) on the cloud-based central backup server. The central server provides for a more reliable web-based user interface for monitoring the sensor data that is automatically collected on site by the main controller that is in wireless communication with multiple SCMs. The central server also serves to reset a watchdog timer running on the main controller so that the main controller can be automatically disabled in the event that a rogue greenhouse operator attempts to disconnect it from a monitoring service of the central server, move greenhouse components to another site or network location, or otherwise attempt to improperly reconfigure the greenhouse.

Additional aspects and advantages will be apparent from the following detailed description of embodiments, which proceeds with reference to the accompanying drawings.

### BRIEF DESCRIPTION OF THE DRAWING FIGURES

FIG. 1 is a block diagram of a greenhouse control system.

FIG. 2 is a block diagram of vining and mix tanks systems.

FIG. 3 is a screen capture of a configuration menu for selecting preprogrammed recipes for each of six greenhouse bays shown in FIG. 1.

FIG. 4 is an end view of a drip tray for a vining system.

FIG. 5 is a block diagram of pond and mix tanks systems.

FIG. 6 is a block diagram of an environmental SCM and its associated sensor inputs and control outputs communicatively coupled to peripheral devices.

FIG. 7 is a flow chart showing a process of developing, synchronizing, and selecting for a greenhouse bay, a preprogrammed recipe.

FIGS. 8-17 are a set of screenshots showing a user interface for remote monitoring, configuration, and administration of a greenhouse control system.

### DETAILED DESCRIPTION OF EMBODIMENTS

### Introduction

Initially, one or more expert hydroponics personnel, optionally working from a centralized service center remote from the greenhouse location, selects seeds for a predefined greenhouse system. The greenhouse system has a main controller preprogrammed to accommodate the selected greenhouse crops and local environmental variables. The expert or experts select seeds specifically suited to a greenhouse client's source water nutritional analysis results, local market demands, climate temperatures and day length at the location of the client's greenhouse. Seeds are selected from a curated list of tested seed varieties bred by centralized chief growers and select third-party breeders around the world. Seeds may be heirloom varieties or commercial varieties developed by breeders, particularly those specializing in non-genetically modified organism (non-GMO), disease resistance, and adaptability.

Each seed variety has characteristic criteria including watering, nutritional, environmental, and gardening maintenance activities, which change over the lifecycle of the crop. Therefore, each seed variety's set of characteristics can be used to develop a predefined set of instructions that—based on specific light level targets, sensor data, and plant location in the greenhouse—automate the interaction of a greenhouse's operations such as irrigation, fertilizer injection, heating or cooling temperature controls, shading, carbon dioxide levels, and control of other peripheral devices so as to create the growing environment for the seed variety. A predefined set of instructions corresponding to a specific seed variety is referred to as recipe data, or simply, a recipe.

With respect to the distributed control system of the present disclosure, recipes are developed by hydroponic experts and provided through the internet to hydroponic greenhouses anywhere in the world. The distributed control system currently has 65 custom recipes, including 25 basic recipes for the most common types of fresh market produce items, and can be tailored to accommodate most commercial crops, including vining crops such as tomatoes and berries and leafy crops such as basil, spinach and arugula. The control system can store virtually unlimited numbers of recipes, so a subset of recipes may be selectively made available to specific growers.

### Overview of Control System

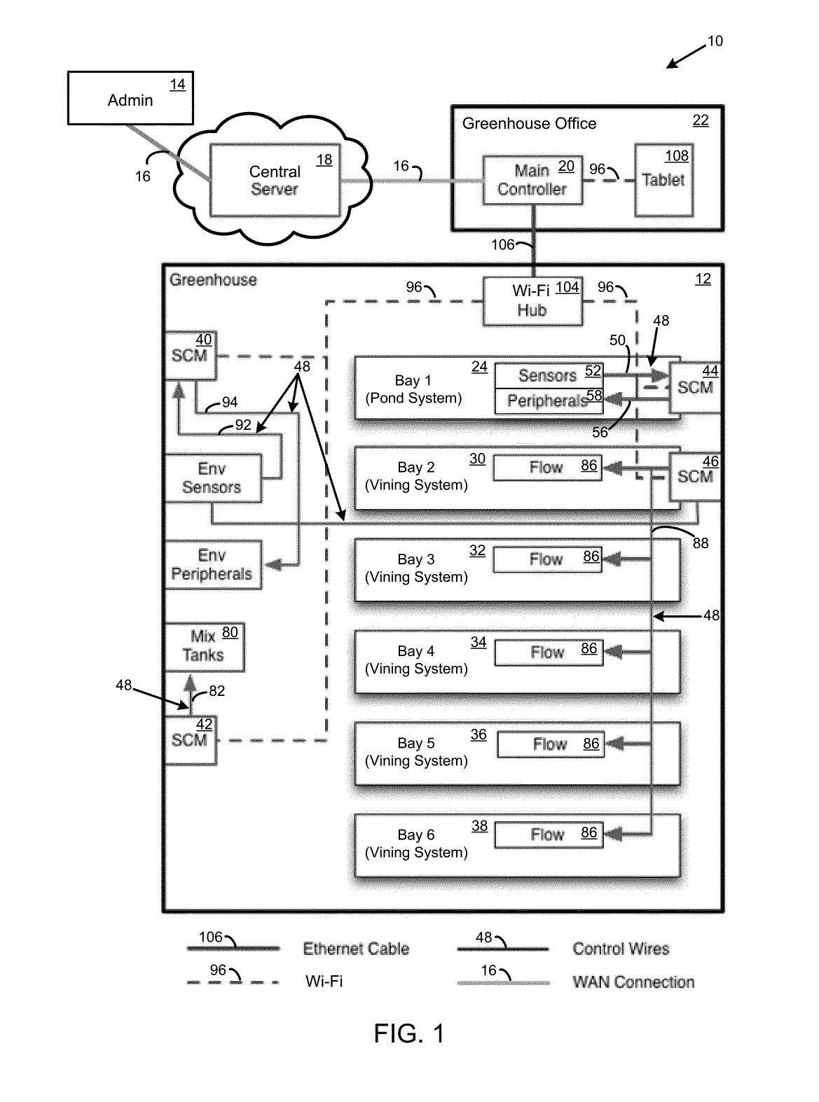

FIG. 1 is a block diagram of the topology of a distributed control system 10 for selecting, monitoring, and administering hydroponic nutrient solution mixtures tailored to preselected crop varieties suited for a greenhouse 12. Centralized hydroponics experts use an administrative computer 14 (or admin 14) in communication through a wide area network (WAN) connection 16 with a central server 18 provided by a third-party cloud service provider to view data provided by an (onsite) main controller 20 at a client's greenhouse office 22.

The greenhouse 12 is a GP-20 greenhouse system available from Got Produce? Franchising, Inc. of San Francisco, Calif. The GP-20 greenhouse system includes a 20,000 square foot greenhouse having one environmental growing zone and up to six bays, with each bay supporting multiple crop rows and each crop row being irrigated by a common fertigation system that delivers targeted recipes that may be tailored so as to independently control each row. Some other embodiments may include a dome greenhouse system, which is a geodesic dome greenhouse including one environmental growing zone and up to two bays. In some other embodiments, the greenhouse 12 may be a GP-50 or GP-100 with 12 or 24 bays, respectively, also available from Got Produce? Franchising, Inc.

For purposes of this disclosure, an environmental growing zone, sometimes called an environment or a zone, is an area inside of a greenhouse monitored by environment sensors or controlled by environment peripheral devices. Environment sensors, also referred to as simply sensors, are devices that sense and convert readings of growing environmental conditions, such as internal or external ambient air temperature, pH, salinity (electrical conductivity, or EC), water temperature, wind, humidity, and other conditions, into a voltage value or a current value that can be monitored. Peripheral devices (or simply, peripherals) include or control heaters, fans, pumps, shutters, water and carbon dioxide gas flow valves, and other devices that establish the desired growing environment and foster plant growth within greenhouse bays. A bay is an area inside the greenhouse that is used to grow a specific type or category of crop.

Bays can be configured to accommodate any combination of pond or vining systems. The present inventor, however, recognized that by including at least one pond system 24 within the interior confines of the greenhouse 12, the relatively large reservoir of water stored in the pond system 24 would provide a natural temperature regulator for ambient air inside the greenhouse 12 and its five vining crop systems 30, 32, 34, 36, and 38. This is so because the water stored inside of the pond stabilizes the greenhouse 12 internal ambient air temperature by releasing stored heat during colder nighttime hours, and absorbing heat during the warmer daytime hours. Without the temperature regulating effects of the water, heating and cooling devices would be more frequently operated to maintain a stable internal ambient air temperature (e.g., 74 degrees+/−2 degrees) throughout a day's temperature fluctuations. As a result of the water, however, less energy is expended for operating such heating and cooling devices. Thus, growers using the greenhouse 12 configuration usually qualify for Low Carbon Footprint (LCF) certification from the Carbon Trust organization.

The greenhouse 12 has multiple sensor-control modules (SCMs) 40, 42, 44, and 46. Generally, an SCM is a dedicated sensor kit—typically including an embedded microprocessor, memory, and wireless connectivity capability—that supports multiple (e.g., eight) sensor inputs and multiple control outputs. According to one embodiment, the SCMs are available from Got Produce? Franchising, Inc. and include a printed circuitry board (PCB) having a programmable ATmega328 microcontroller available from Amtel Corp. of San Jose, Calif., an ESP8266 serial Wi-Fi Wireless Module available from SparkFun Electronics of Niwot, Colo., and associated electrical circuitry. The PCB and its electrical components are housed within a National Electrical Manufacturers Association (NEMA) standard Type 4 (watertight) polycarbonate electrical enclosure available as product model no. WP-25F from Polycase of Avon, Ohio. Skilled persons will recognize, however, that other electrical and enclosure hardware may be used. For example, the SCM control system may be implemented in the form of an application specific integrated circuit (ASIC); as preprogrammed logic circuitry, such as a field programmable gate array (FPGA); or as another programmable processor design that responds to instructions stored on a computer-readable medium.

The four SCMs 40, 42, 44, and 46 communicate with associated sensors using control wires 48. For example, sensor inputs 50 provide connections for various sensors, such as sensor 52 of the bay 1 of the pond system 24, and control outputs 56 are relays and signals that control peripheral devices, such as peripherals 58, according to a set of parameters associated with one or more sensors. A parameter, for example, may include a sensor target value, an upper limit, a lower limit, or a range of values. Thus, generally speaking, the types of sensor inputs and control outputs define a type of SCM. And in some embodiments, e.g., for a typical GP-20 greenhouse, there are four types of SCMs. These four types are briefly explained in the following four examples.

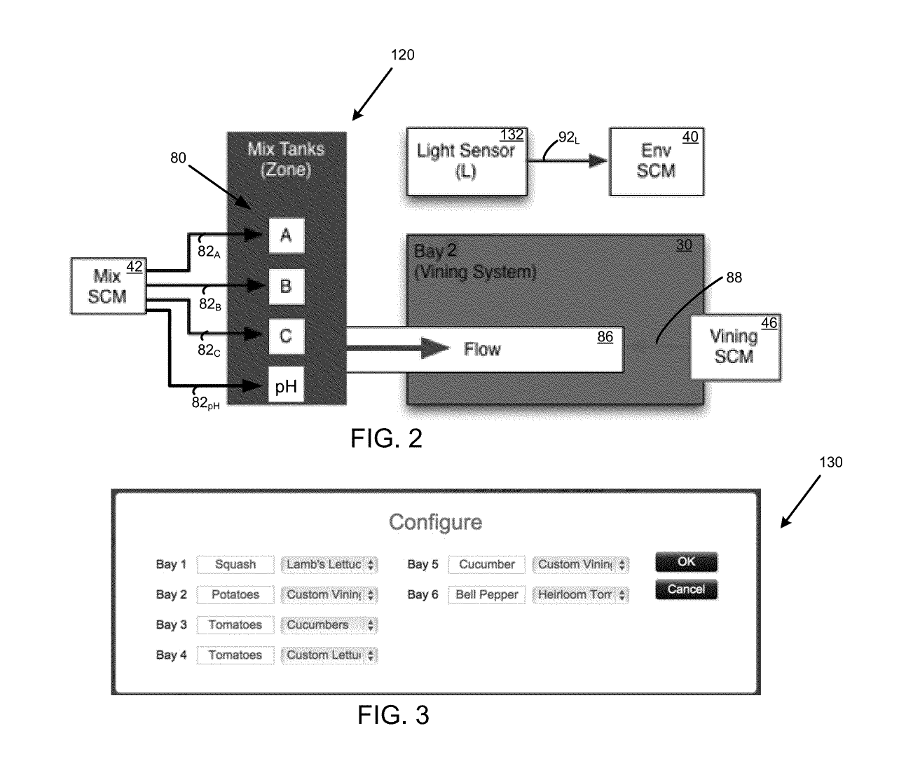

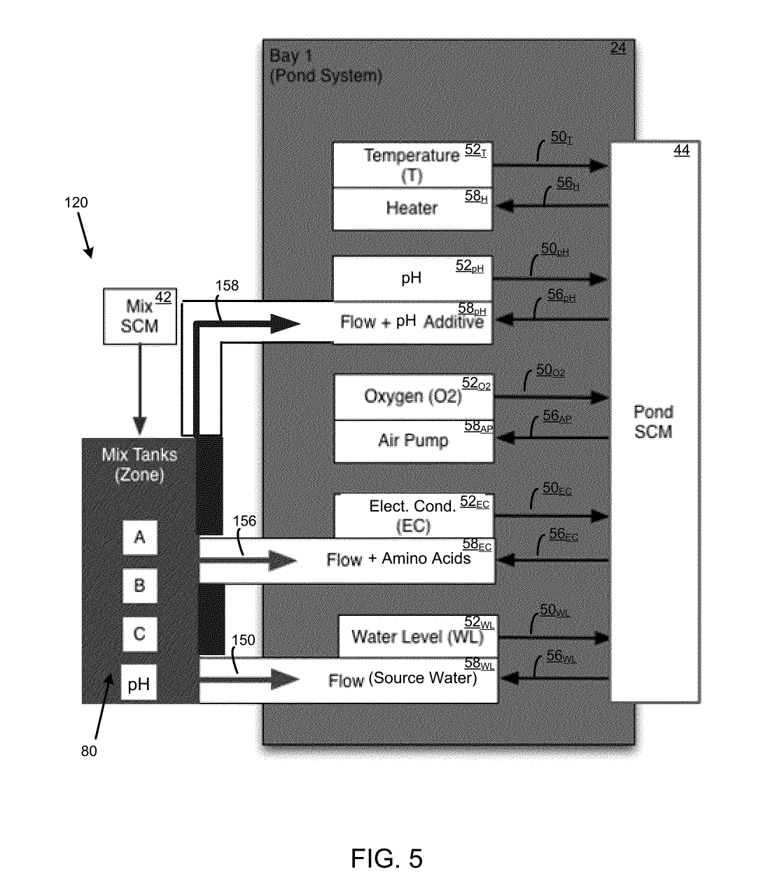

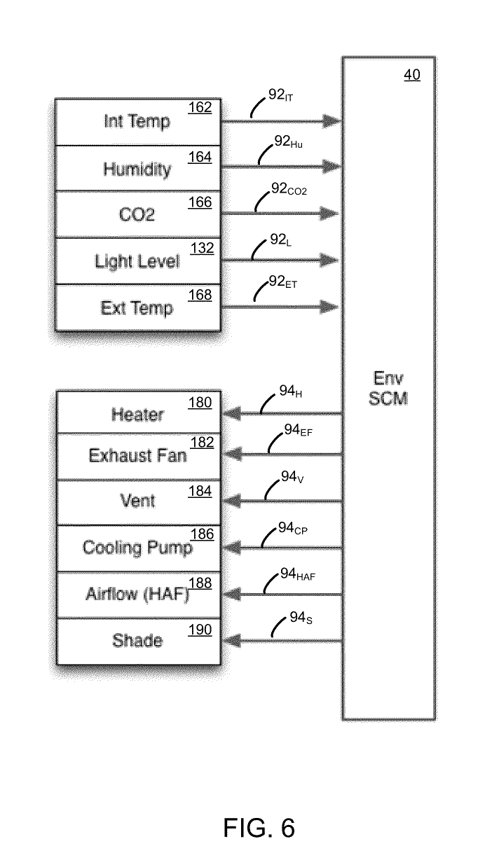

In a first example, the mix SCM 42 (see also FIG. 2) senses amounts of raw ingredients remaining inside mix tanks 80 (e.g., to notify a user of a tablet computer 108 to refill certain ones of the mix tanks 80), and has control outputs 82 for controlling the metering and administering of recipes for each corresponding bay, as described in later paragraphs. In a second example, the vining SCM 46 (see also FIG. 2) controls up to eight flow valves independently for eight bays carrying vining crops. For simplicity, however, independently controlled flow valves 86 of FIG. 1 share a common reference number, as does the control outputs 88 that control the valves 86. In a third example, the pond SCM 44 (see also FIG. 5) senses and controls parameters of the pond system 24 (water temperature, pH, and other conditions). Finally, in a fourth example, the environmental SCM 40 (see also FIG. 6) sensor inputs 92 and control outputs 94 monitor and manage conditions impacting the environment of a zone (e.g., ambient internal and external air temperatures, air flow, and other conditions).

The four SCMs 40, 42, 44, and 46 communicate with one another, and with the main controller 20, through a wireless network 96 provided by a Wi-Fi networking device (e.g., hub) 104. The Wi-Fi hub 104 is connected to the main controller 20 using a local area network (LAN) 106 connection (e.g., Ethernet cable). The Wi-Fi network 96 is used for passing control and sensor information between the main controller 20 and the four SCMs 40, 42, 44, and 46. A tablet computer (or other mobile device) 108 is also a member of the Wi-Fi network 96 so that a user of the tablet computer 108 may log into a system administrative website served by the main controller 20.

Skilled persons will understand that the configurations of the WAN 16, the LAN 106, the wireless network 96, and the control wires 48 can include any appropriate network, including the internet, a cellular network, any other such network or combinations thereof. Components used for such a system can depend at least in part upon the type of network and environment selected. Protocols and components for communicating via such networks are known and will not be discussed herein in detail. Furthermore, communication over the network can be enabled via wired or wireless connections and combinations thereof. In this example, the network includes the internet, as the environment includes the cloud-based central server 18 for receiving requests from user devices and serving content in response thereto, although for other networks an alternative device serving a similar distributed control system purpose could be used, as would be apparent to skilled persons. Skilled persons will also recognize that FIG. 1 is a simplified depiction of the sensor inputs and control outputs, and that some embodiments may include variations in the wired or wireless communications technologies between the greenhouse 12 components.

When recipe instructions stored on a computer readable medium of the main controller 20 are then executed by the main controller 20, the instructions configure the main controller 20 to dynamically and automatically tailor the growing environment according to a specific plant's needs for optimum growth. The main controller 20 polls the four SCMs 40, 42, 44, and 46 in round-robin fashion and responds to out-of-limit conditions that exist when a sensor measures a value outside the expected parameters (e.g., above or below its range). The main controller 20 analyzes the sensor data and triggers associated peripherals to activate and control the greenhouse growing environment. In some embodiments, an SCM is polled in an interval of 30 seconds divided by the total number of SCMs in the system. This yields a 30-second cycle time for polling all the SCMs and automatically controlling the greenhouse 12.

Any additional pruning, picking, harvesting, pest control or other plant maintenance needs specific to each seed variety are communicated from the admin 14 to the greenhouse office 22 through an online operations manual portal that is accessible via a menu tab in user interfaces served by the main controller 20. Thus, these growing traits, which further facilitate successful greenhouse operations, are now made available directly to clients through the distributed control system 10.

As described in the following pond, vining, mix tank, and environmental system descriptions, the four SCMs 40, 42, 44, and 46 provide for total control of a zone. Additional details concerning the pond construction, onsite control system, and individual control loops for the SCMs are described in the U.S. patent application Ser. No. 13/662,134, which is incorporated by reference. For example, the '134 application describes a processor Cl that, in some embodiments, may comprise the main controller 20.

### Mix Tanks System

FIG. 2 shows a typical mix tanks system 120. According to the GP-20 greenhouse embodiment, there is one mix tanks system 120 per zone, although some embodiments may include additional mix tanks systems. The mix SCM 42 controls a group of four mix tanks A, B, C, and pH, used to deliver a preselected recipe solution (dose) for a specific bay selected by a greenhouse operator. FIG. 3 shows an example screenshot of a crop configuration dialog box 130 of a user interface menu served by the main controller 20 for configuring recipes for the six bays of the greenhouse 12.

The following table 1 sets forth an example of ingredients used to fill the mix tanks.

TABLE 1

| | | Tank A | Tank B | | Tank C | Tank pH |
|---|---|---|---|---|---|---|
| Macro Nutrients | | | | | | |
| Calcium Nitrate | Ca(NO₃)₂ | 60.2 kg | | | | |
| Soluble | | | | | | |
| Potassium Nitrate | KNO₃ | 10.1 kg | 18.9 | kg | | |
| Metalosate | Ca | | | | 650 ml | |
| Calcium | | | | | | |
| Iron Chelate | Fe EDTA | 1 kg | | | | |
| Magnesium | MgSO₄ | | 38.7 | kg | | |
| Sulphate | | | | | | |
| Calcium Chloride | CaCl₂ | | | | | |
| Potassium | K₂SO₄ | | 14.2 | kg | | |
| Sulphate | | | | | | |
| Monopotassium | KH₂PO₄ | | 5.8 | kg | | |
| Phosphate, MKP | | | | | | |
| Phosphoric | H₃O₄P | | | | | 1 drum |
| Acid Food | | | | | | (50 gal.) |
| Grade (clear) | | | | | | |
| Micro Nutrients | | | | | | |
| Sodium | Na₂MoO₄ | | 1 | g | | |
| Molybdate (Mo) | | | | | | |
| Boron | B | | 120 | g | | |
| Copper Chelate | Cu | | 12.9 | g | | |
| Manganese | Mn | | 96 | g | | |
| Zinc | Zn | | 91 | g | | |

### Vining System

FIG. 2 also shows that the vining SCM 46 controls the flow of hydroponic solution into the vining system 30. A light sensor 132 provides via sensor input 92_{L} a measure of sunlight in joules per square centimeter to the environmental SCM 40. The environmental SCM 40 then provides this information to the main controller 20, which checks the measure against a preconfigured threshold parameter associated with a preprogrammed mix and irrigation recipe for the vining system 30. In response to the measure exceeding a preselected threshold of the recipe, the main controller 20 sends three commands. The first command is to open a corresponding solenoid irrigation valve for the particular crop sensor calling for irrigation. The second command is to activate the irrigation pressure pump. The third command is to activate stepper motors and drives according to a preprogrammed recipe. A motor turns its corresponding pump, which then pulls a specified amount of nutrient from a corresponding nutrient tank, and which then flows into an inline injector that feeds into an irrigation out flow.

When the main controller 20 requests that the vining SCM 46 activate its vining flow valve 86, the mix SCM 42 proceeds to mix the appropriate preprogrammed recipe, entitled “Custom Vining” (FIG. 3) for potatoes growing in the bay 2 of the vining system 30. The following table 2 sets forth an example mix and irrigation recipe (also referred to as a vining recipe), which also includes a preselected irrigation trigger threshold.

TABLE 2

| Vining | | | |
|---|---|---|---|
| Recipe | Quan- | Unit | |
| Component | tity | (Rate) | Notes |
| Doses | 2 | ×30 | 2 × 30 sec. = 1 minute dose duration |
| (duration) | | sec. | |
| Tank A Mix | 450 | ml/30 | 450 ml/30 sec. = 15 ml per second. |
| | | sec. | Precise pumping equipment provides for |
| | | | 1.5 ml of solution pumped per pump |
| | | | revolution. Therefore, 15 ml of solution |
| | | | pumped per sec. equates to precisely 10 |
| | | | pump revs. per sec. And 450 ml/1.5 ml |
| | | | per pump rev. = 300 total revs. per 30 |
| | | | dose cycle. The total number of revs. |
| | | | may be generated at a constant or a |
| | | | variable rate during the 30 sec. dose |
| | | | cycle, depending on whether the recipe |
| | | | is for a crop that prefers its doses |
| | | | administered at a constant or variable |
| | | | (e.g., front- or back-loaded) |
| | | | concentration during the dosage cycle |
| | | | duration. |
| Tank B Mix | 100 | ml/30 | 100 ml/30 sec. = 3. 3̅3̅ ml per sec. A |
| | | sec. | dose of 3. 3̅3̅ ml per sec. equates to |
| | | | precisely 2. 2̅2̅ pump revs. per sec. |
| | | | 100 ml/1.5 ml per pump rev. = 66. 6̅6̅ |
| | | | total revs. per 30 dose cycle, applied at |
| | | | a constant or a variable rate. |
| Tank C Mix | 100 | ml/30 | 100 ml/1.5 ml per pump rev. = 66. 6̅6̅ |
| | | sec. | total revs. per 30 dose cycle, applied at |
| | | | a constant or a variable rate. |
| Tank pH | 100 | ml/30 | 100 ml/1.5 ml per pump rev. = 66. 6̅6̅ |
| (Acid) Mix | | sec. | total revs. per 30 dose cycle, applied at |
| | | | a constant or a variable rate. |
| Irrigation | 400 | joules/ | Threshold accumulation of sunlight |
| Trigger | | cm² | energy used to initiate irrigation |
| Threshold | | | sequence |

Skilled persons will recognize that the flow rate and specific recipe components work in concert to provide directly controlled nutrient delivery having consistent nutrient parts per million (PPM) levels in solution, which is then provided based on sunlight energy absorbed by the plants. By using the system 10, a greenhouse operator need not measure or even understand the need for specific PPM because optimal PPM levels are predetermined and made available by the cooperation of (1) the preprogrammed formulation of recipe components, (2) a predetermined number and style of irrigation drip emitters, and (3) high-precision flow rates, all three of which are described as follows.

First, the recipe formulation (e.g., table 2) provides for application of predetermined volumes of the nutrient mixtures identified in table 1. Second, the vining systems 30, 32, 34, 36, and 38 are each preconfigured with irrigation drip emitters having a known gallon per hour (GPH) flow rate. Typically, most crops will use 0.5 GPH emitters, available from Netafim USA of Fresno, Calif., but 1.0 GPH emitters may be employed for some crops. Based on the table 2 recipe, each 0.5 GPH emitter applies 0.008 3̅ gallons of solution following a trigger. Depending on the crop variety, a vining system may be preconfigured to include 1,000 drip emitters, in which case the table 2 recipe produces a total of 8. 3̅ gallons of solution following a trigger. Third, precise dosages of solution are delivered to a specific crop using high-precision flow rate pumping equipment including pump heads, stepper motors, and stepper drives. For example, a pump head product model no. STQ3CKC and stepper motor product model no. 110746 are available from Fluid Metering, Inc. of Syosset, N.Y. A programmable micro-stepping drive product model no. ST5-Q-EN is available from Applied Motion Products of Watsonville, Calif.

The pumping equipment precisely controls the milliliters of solution provided per revolution of the pump equipment. The stepper drive controls how many milliliters of each nutrient that a pump delivers by relaying to the pump motor a drive command that (generally) specifies the desired revolutions per second. The aforementioned pumps are extremely precise and can inject dosages in increments of 1/100 (0.01) ml, irrespective of the flow rate of incoming or outgoing water.

Once the nutrient solution is injected into the outgoing water supply pipe, it passes through a 12-element static mixer to evenly disperse all ingredients through the water and then into a so-called batch pipe that holds an irrigation batch of water and nutrients (i.e., solution) and checks the EC and pH levels of the solution before it is passed on to the crops. The EC and pH sensor readings need not trigger nutrient injections because, as discussed previously, those are triggered based on sunlight (or periodically) and are deactivated once a precise predetermined dosage is applied. Thus, the EC and pH are used as a fail-safe and to confirm the correct solution was mixed before it is actually applied to crops. In contrast, the industry standard is for the EC and pH sensors to trigger the nutrient injections and to let them continuously inject until an EC and a pH threshold is met, which leaves no precise way to adjust the concentrations of individual nutrients, relative to other nutrients, and thereby tailor the nutrient composition of a fertigation solution.

While one flow valve 86 is active, other flow valves 86 are already deactivated. This way, one set of irrigation pipes is used to deliver various recipes to different crops. A short flush cycle toward the end of a dosage (e.g., after a front-loaded dosage) is used to remove excess solution from the common pipe so that the excess solution in the pipe is not inadvertently pumped to a different crop that is subsequently triggered.

After a solution is applied to crops of a bay in response to the sunlight energy measurement exceeding a threshold, the main controller 20 resets the sunlight energy measurement for that bay to zero so that the sunlight energy measurement can begin re-accumulating. The delay period between consecutive applications of solution, therefore, is based on how quickly sunlight energy accumulates in the crops.

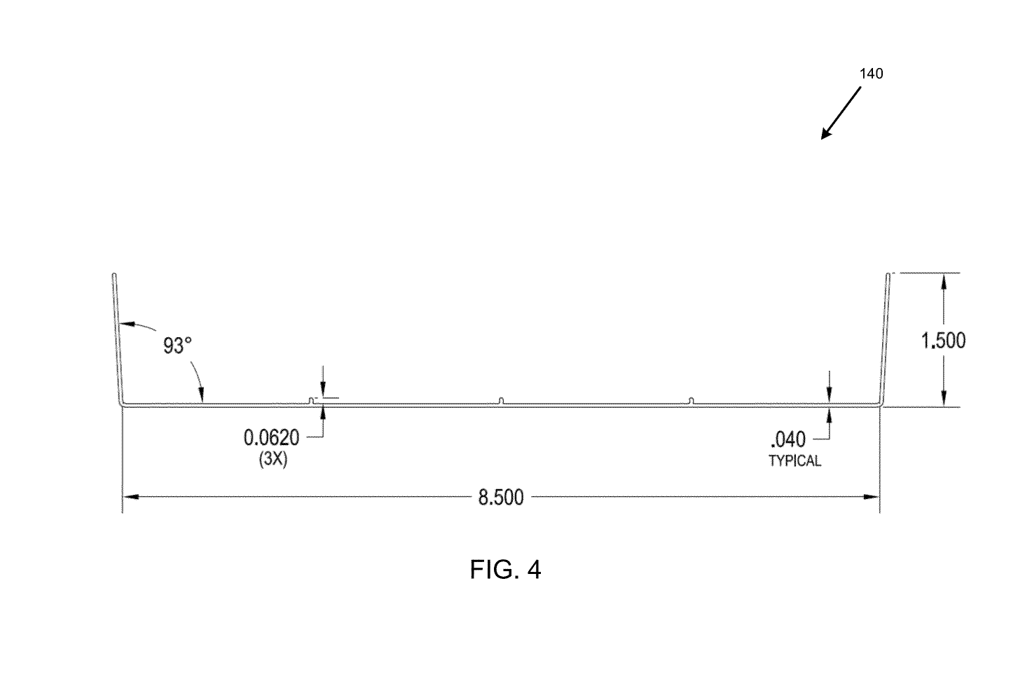

Unabsorbed solution applied to crops (i.e., runoff) is captured in a PVC drip tray 140 of FIG. 4. The drip tray 140 catches the runoff and returns it to a drain system and sump tank. In some cases, the drain water is reintroduced into the system 10, and in other instances it is gathered and used for outdoor irrigation of crops. Because the preprogrammed recipes are specific to crop types and flow volumes, and the application of solution is precisely controlled and administered based on measured sunlight, there is less runoff than there would be in conventional systems that operate on preset intervals and other rudimentary irrigation controls. For example, a typical five-bay vining system of the greenhouse 12 produces about 100 gallons of runoff over the course of a typical day, whereas conventional systems generally produce about 30% more volume of runoff. In some embodiments, the amount of runoff of the greenhouse 12 can be further reduced by implementing incremental (temporal) recipe changes accommodating the changing crop sizes and productivity as the crops mature.

When multiple bays call for solution at the same time, and there is one mix tanks system to accommodate multiple requests, then the requests for solution are entered into a first-in first-out (FIFO) queue and dispatched accordingly. Of course, each bay is irrigated according to its own recipe. And the recipes, selected crops, and layout of the greenhouse 12 are designed so that there is always a sufficient amount of time available for processing a complete queue before the next call for irrigation. In other words, the system is designed so that no bay would produce multiple entries in the FIFO queue at any given moment.

### Pond System

FIG. 5 shows that the pond system 24 includes a water temperature sensor 52_{T}, a pH sensor 52_{pH}, an oxygen sensor 52_{O2}, an EC sensor 52_{EC}, and a water level (WL) sensor 52_{WL}. The pond SCM 44 provides corresponding sensor input information from these sensors to the main controller 20. The main controller 20 then determines whether to activate corresponding control outputs 56_{H}, 56_{pH}, 56_{AP}, 56_{EC}, and 56_{WL} for, respectively, a heater 58_{H}, a pH solution flow control device 58_{pH}, an air pump 58_{AP}, a nutrient solution flow control device 58_{EC}, or a source water level (WL) flow control device 58_{WL}. Activation of the flow control devices is explained in further detail.

The WL sensor 52_{WL} is used to sense the level of water in the pond's reservoir, and produce a measurement signal on the signal input 50_{WL} that indicates the water level. The measurement signal is received by the pond SCM 44, and transmitted to the main controller 20. The main controller 20 then determines, based on the measurement signal, whether additional source water 150 should be added to the reservoir. If so, then the main controller 20 indicates to the pond SCM 44 that the control output 56_{WL} should be activated to open the source WL flow control device 58_{WL} and thereby add the source water 150 to the pond until the WL sensor 52_{WL} produces on the signal input 50_{WL} a signal indicating a desired water level has been reached. Notably, the WL sensor 52_{WL} does not necessarily cause the mix tanks system 120 to activate any of the tanks 80.

In contrast, the EC sensor 52_{EC} provides for addition of nutrient solution 156 mixed from tanks A, B, and C; and the pH sensor 52_{pH} provides for the addition of an acid solution 158 mixed from the pH tank. In other words, the EC sensor 52_{EC} and the pH sensor 52_{pH} cause the main controller 20 to signal the pond SCM 44 to activate control outputs 56_{EC} and 56_{pH} that open, respectively, the nutrient solution flow control device 58_{EC} and pH solution flow control device 58_{pH}, and to have the mix SCM 42 simultaneously activate its mix tanks 80 according to a preprogrammed pond recipe.

The EC sensor 52_{EC} and the pH sensor 52_{pH} may also cause the pond SCM 44 and the main controller 20 to communicate so that the control output 56_{WL} is activated. In this case, it activates to open the source WL flow control device 58_{WL} such that the source water 150 may flow into the reservoir and dilute the water therein. The sensors 52_{EC} and 52_{pH} monitor the water for proper nutrient concentrations and, when the proper concentration is reached, the main controller 20 signals the pond SCM 44 to disable the flow of the source water 150.

Like the vining system 30, operation of the pond system 24 is also based on preprogrammed recipes. But unlike those of the vining system 30, a recipe for a crop growing in the water of the pond system 24 is based on direct pH and EC measurement values of the water in the reservoir of the pond system 24. For example, EC measurement values are carried via the sensor input 50_{EC} and communicated by the pond SCM 44 over the greenhouse networks 96 and 106 to the main controller 20. When the main controller 20 compares the EC measurement values to preconfigured ranges stored on the main controller 20, and determines the measurements to be too low, the main controller 20 signals the mix SCM 42 to activate a preprogrammed recipe using tanks A, B, and C. The recipe solution is added to the water in doses so as to gradually increase the nutrients available in the water. And when EC measurements are too high, the main controller 20 activates the pond SCM 44 control output 56_{WL} to open the source WL flow control device 58_{WL} so that the source water 150 may be added to dilute the water in the pond reservoir so that the level of nutrients matches a predetermined value. Likewise, the pH of the water in the reservoir is adjusted in much the same fashion.

### Environment System

In the greenhouse 12, there is one environmental SCM per zone. FIG. 6 shows that the environmental SCM 40 senses the sunlight energy signal from the light sensor 132, internal ambient air temperature 162, internal humidity 164, internal CO₂ level 166, and external ambient air temperature 168. The environmental SCM 40 uses signal inputs (identified in FIG. 6 with reference numbers 92 having associated subscripts) to provide information to the main controller 20 for managing the control outputs (i.e., reference numbers 94) and thereby control the following peripheral devices: a greenhouse ambient air heater 180, an exhaust fan 182, a vent 184, a greenhouse ambient air cooling pump 186, a horizontal airflow fan 188, and a shade device 190. For example, temperature and shade settings, which are triggered for both heat and energy retention at night, are triggered if a crop requires additional shading during peak daytime temperatures, or if the cooling system 186 is insufficient (or less efficient) than the shading device 190.

### Data Caching, Remote Monitoring, and Centralized Administration of the Control System

Data is logged in an SQL database hosted on the main controller 20. The central server 18 also has its own SQL database, which the central server 18 synchronizes with that of a selected main controller (e.g., the main controller 20). Synchronization happens at preset intervals and in response to a user logging into the central server 18 interface and selecting a main controller. Accordingly, the main controller 20 operates as a master SQL database server, and the central server 18 maintains its slave copy of the master SQL database. This is commonly referred to as an SQL replication configuration.

This configuration has the advantage of maintaining on the central server 18 a backed up copy of all data stored on the main controller 20, which regularly copies its data to the central server 18. The central server 18 serves as a user interface depicting the data so that remotely located hydroponics experts can use the interface for monitoring greenhouses. The present inventor recognized that the central sever 18 provides a highly reliable cloud-based solution for monitoring greenhouses in remote corners of the world having sporadic internet connectivity. The central server 18 is also responsible for serving as the conduit by which changes are made to a main controller. Furthermore, the central server 18 maintains a watchdog timer (also called a tether timer) that allows a main controller to continue to operate its greenhouse facility on the condition that it regularly refreshes its timer with the central server 18.

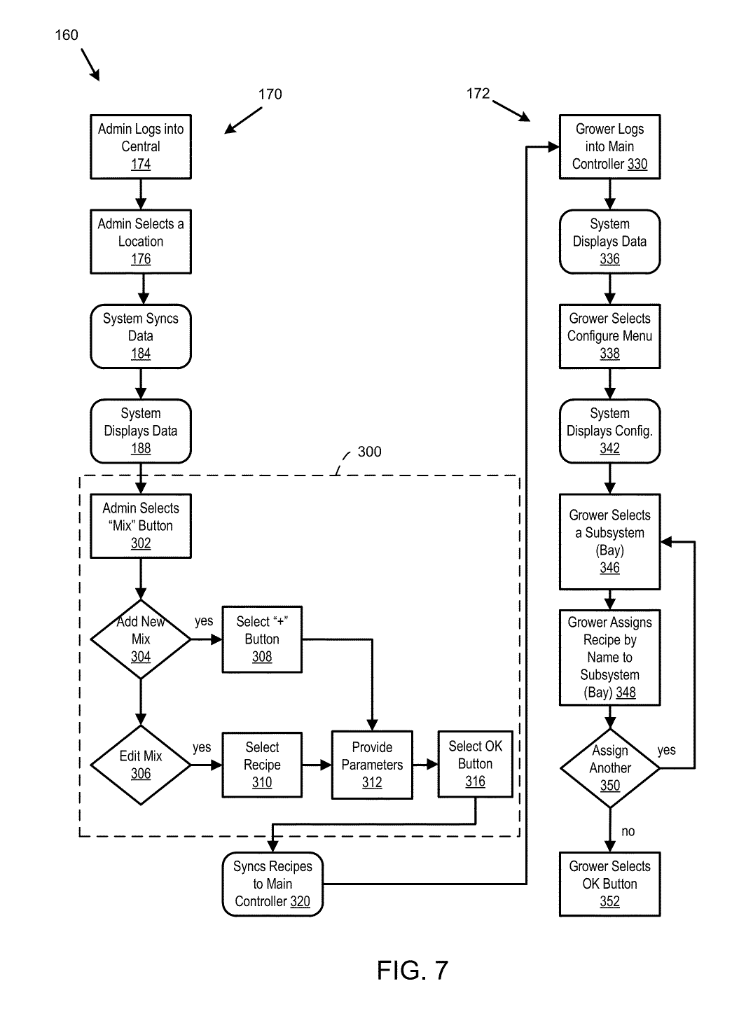

FIG. 7 shows an end-to-end process 160 for configuring the main controller 20. The process 160 shows a first process 170 in which a hydroponics expert prepares selected recipe data on the central server 18 and a second process 172 in which a grower or expert assigns recipes to bays, as has been shown and described with respect to FIG. 3. For purposes of clarity, it is noted that rectangular items in the flowchart of FIG. 7 represent actions performed by users, whereas the rounded rectangular items represent actions performed by computing devices or the various components of the control system 10. Also, the first and second processes may be performed independently and are shown in one diagram for ease of description.

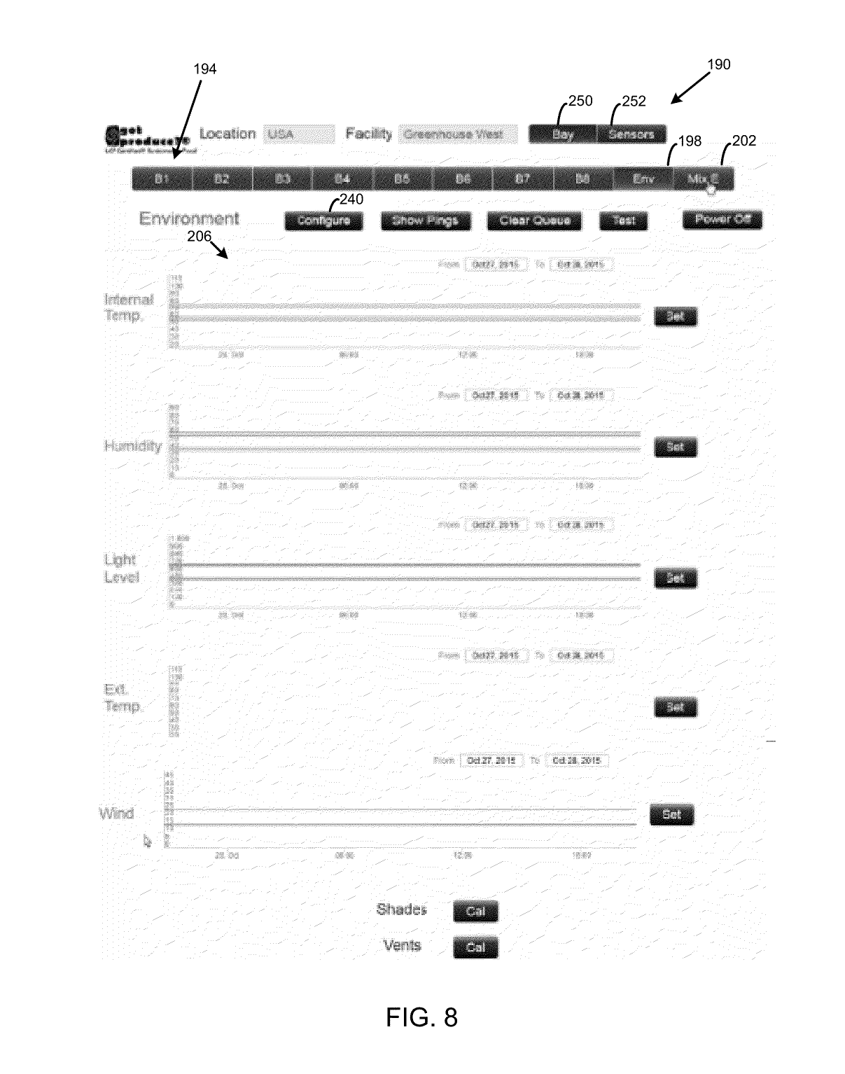

With respect to the first process 170, a hydroponics expert connects their workstation (e.g., the admin 14) to the central server 18 by logging into 174 a password protected website on the central server 18. The central server 18 website shows several greenhouses that may be located around the world and are accessible through a TCP/IP connection. The hydroponics expert selects 176 a main controller (e.g., the main controller 20) of one of the greenhouses. Selecting a greenhouse causes the central server 18 to update 184 its local database by copying (synchronizing) the master database of the selected main controller 20. The central server 18 then shows a user interface reflecting the data obtained from the selected main controller 20. For example, FIG. 8 shows a user interface 190 in the form of a website showing data obtained from a greenhouse located in the United States, and named “Greenhouse West.” The expert can then use the central server 18 user interface 190 to create a new recipe, modify an existing one, or perform other administrative and monitoring functions.

In the example of FIG. 8, across an area near the top is a upper bar 194 of buttons which shows the different bays. In this particular greenhouse, there are eight bays. There is also an “Env” button 198 for showing environmental data and a “Mix E” button 202 for controlling an external mix system used to irrigate crops outside the greenhouse 12. FIG. 8 shows that the user interface 190 is presenting line graphs 206 of greenhouse environmental data including internal temperature, humidity, light level, and external temperature, and wind speed monitored for all the bays “B1”-“B8.”

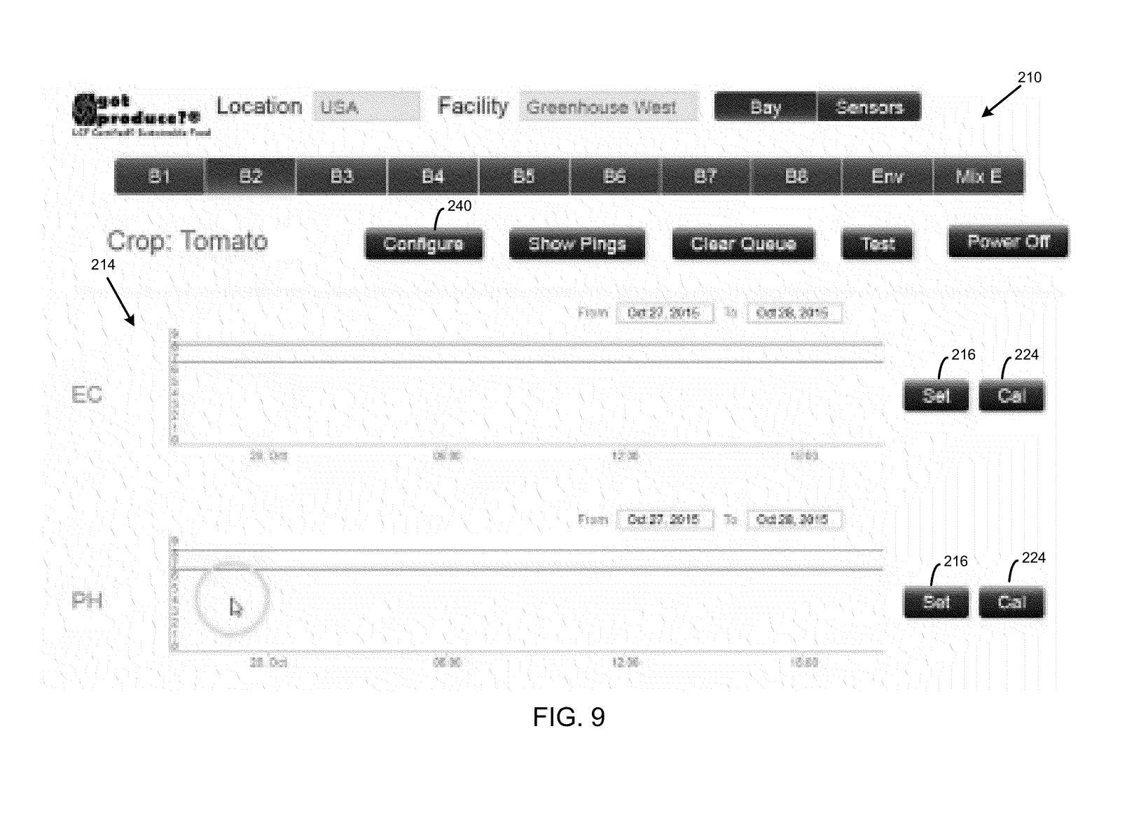

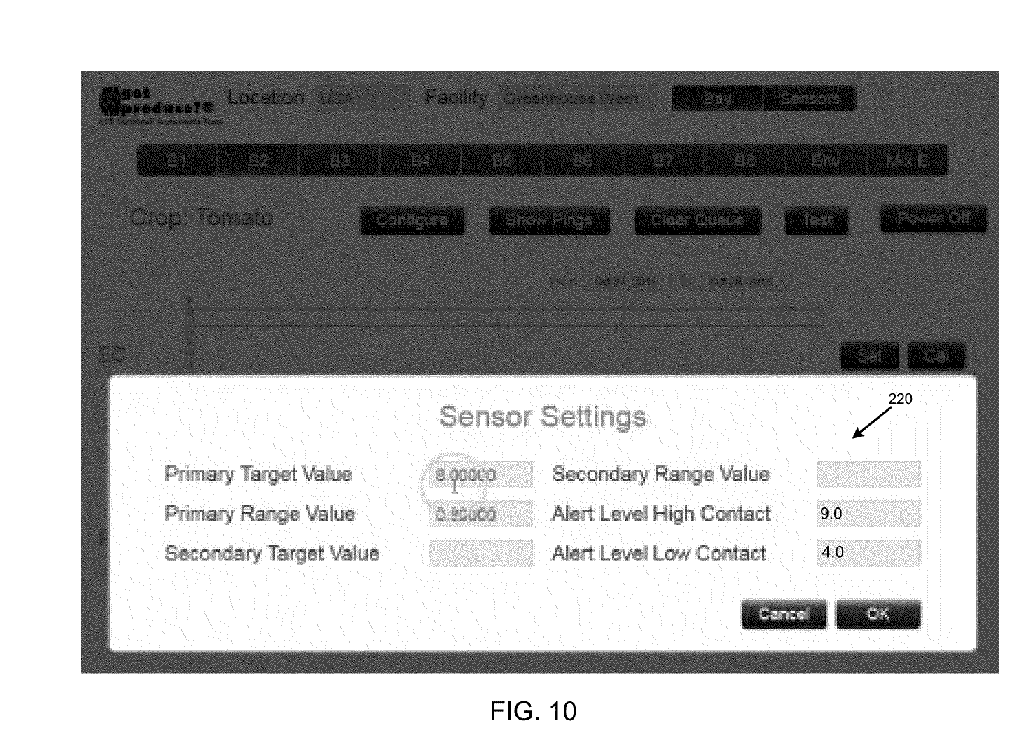

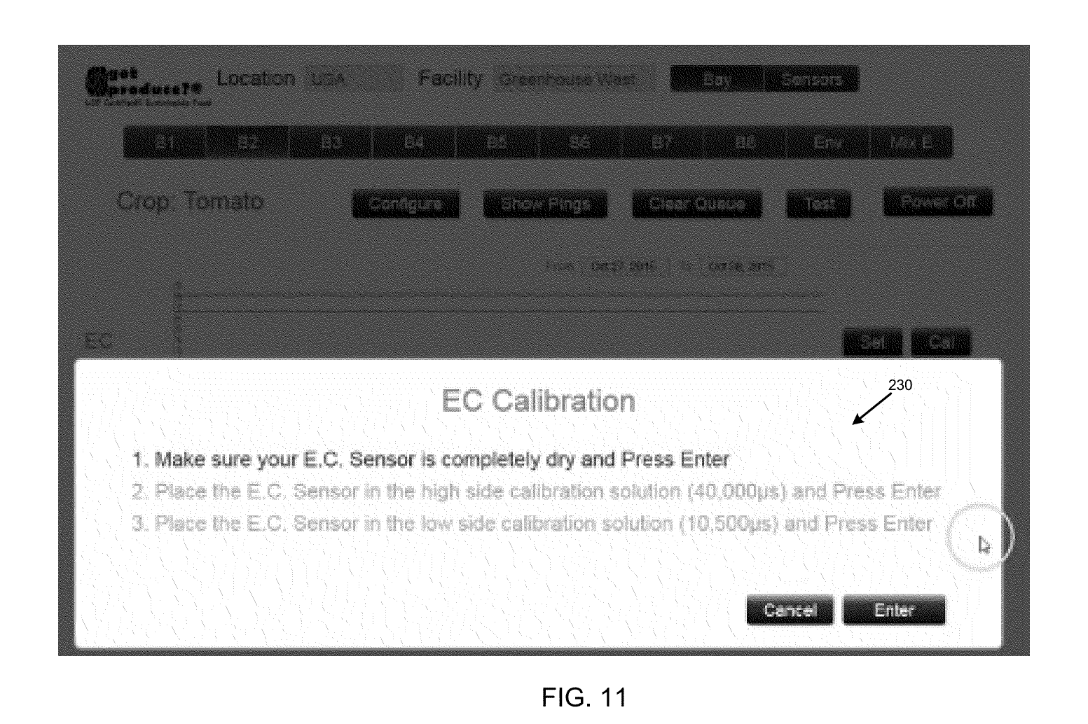

FIG. 9 shows how the user interface 190 changes to a specific bay monitoring view 210 after selecting a “B2” button from a set of bay buttons “B1”-“B8.” The bay monitoring view 210 for bay number two shows line graphs 214 of monitored nutritional information. In this particular bay, bay 2, the greenhouse is hydroponically growing a crop of tomatoes, so its shows EC and pH levels are being monitored for the tomato crop. For this view 210, the user (typically the expert) can set nutrient limits and calibrate sensors. For example, by clicking on a “Set” button 216 associated with a particular monitored nutrient, the expert is shown a dialog box 220 (FIG. 10) for entering primary and secondary target levels along with an alert level. As shown in FIG. 10, the expert wants to be contacted if there is a high reading of 9.0 pH or a low reading or 4.0 pH. FIG. 9 also shows that sensors can be calibrated from the bay monitoring view 210 by clicking a calibrate (“Cal”) button 224 that produces a dialog box 230 (FIG. 11) for guiding an onsite calibration process.

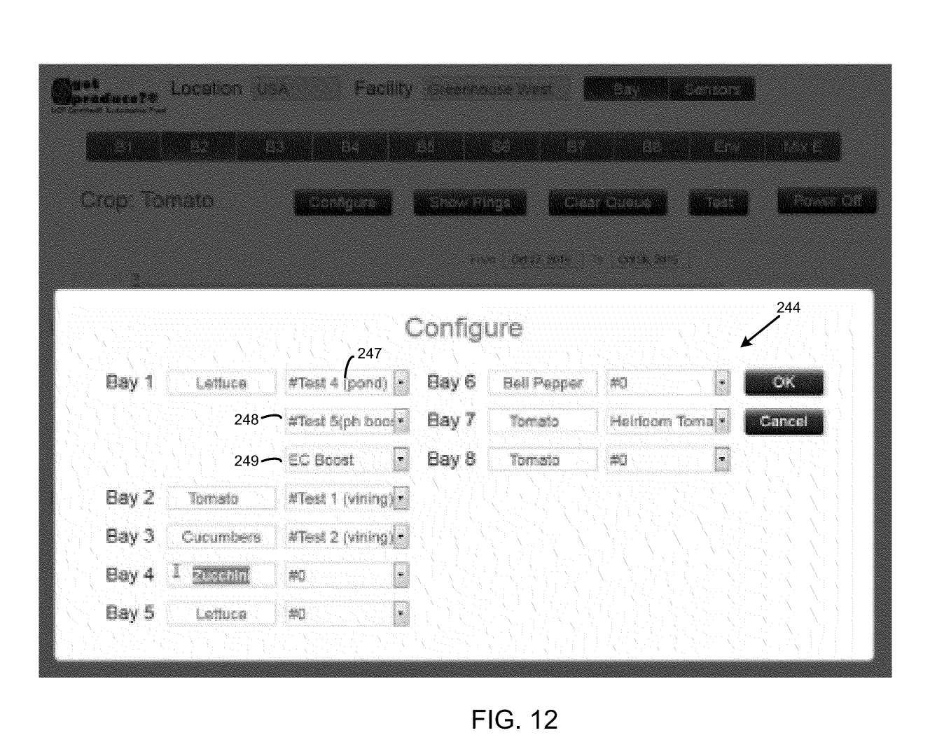

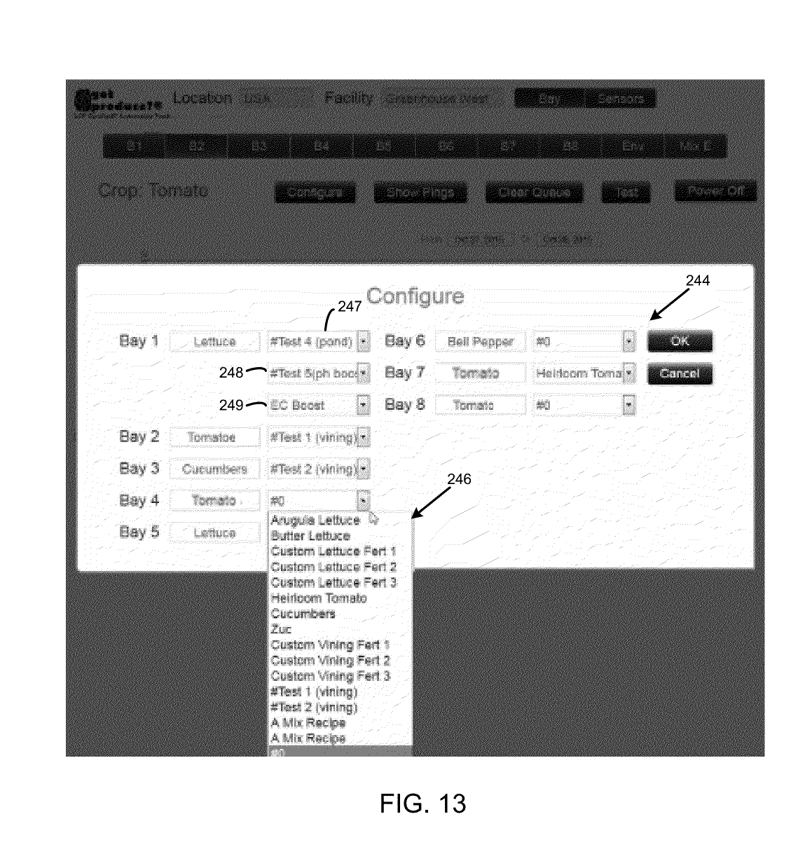

FIG. 9 also shows a “Configure” button 240 that is used for changing the mix of crops in a crop configuration dialog box 244 (FIGS. 12 and 13), which is for eight bays instead of the six bays shown in the crop configuration dialog box 130 of FIG. 3. As shown and described previously, the crop configuration dialog box 244 lists all of the bays within the greenhouse. When the user wants to change a specific crop, they can type the name of the crop (FIG. 12) and select a preprogrammed recipe (FIG. 13). For example, FIGS. 12 and 13 show the user reconfiguring bay number four from a zucchini crop to another tomato crop. A recipe list 246 (FIG. 13) shows a list of custom, preprogrammed recipes that have been already tailored for the “Greenhouse West” source water and seed varieties. Accordingly, the user may select the “Heirloom Tomatoes” recipe to configure the bay four to grow tomatoes from seeds previously provided to the greenhouse operator.

FIGS. 12 and 13 also shows that a “Bay 1” is configured as a pond system that has three associated preprogrammed recipes: so-called fill recipe 247, pH boost recipe 248, and EC boost recipe 249. Fill recipe 247 is employed when the pond is filling with water, either initially or in subsequent top-offs and is based on the volume of water used to fill the pond. The boost recipes 248 and 249 are, according to some embodiments, straight injections of concentrated fertilizer (for increasing EC level) or acid (for decreasing pH) in response to the EC sensor 52_{EC} and the pH sensor 52_{pH} (FIG. 5), respectively, indicating the levels are out of range and calling for a correction. Accordingly, boost recipes for the pond are based on a known volume of nutrient needed to change the EC or pH level by 0.01 units, and the main controller may deploy a boost recipe by adding nutrients in amounts sufficient to change by 0.05 units until a desired threshold is reached. Note that adjusting nutrient levels is not a linear function of the current nutrient level, so the recipes actually account for the non-linear relationship between the current nutrient level and the desired level. For example the pH boost recipe 248 will call for less volume of acid when changing the pH from 5.9 to 5.8 then it does when changing it from 8.0 to 7.9.

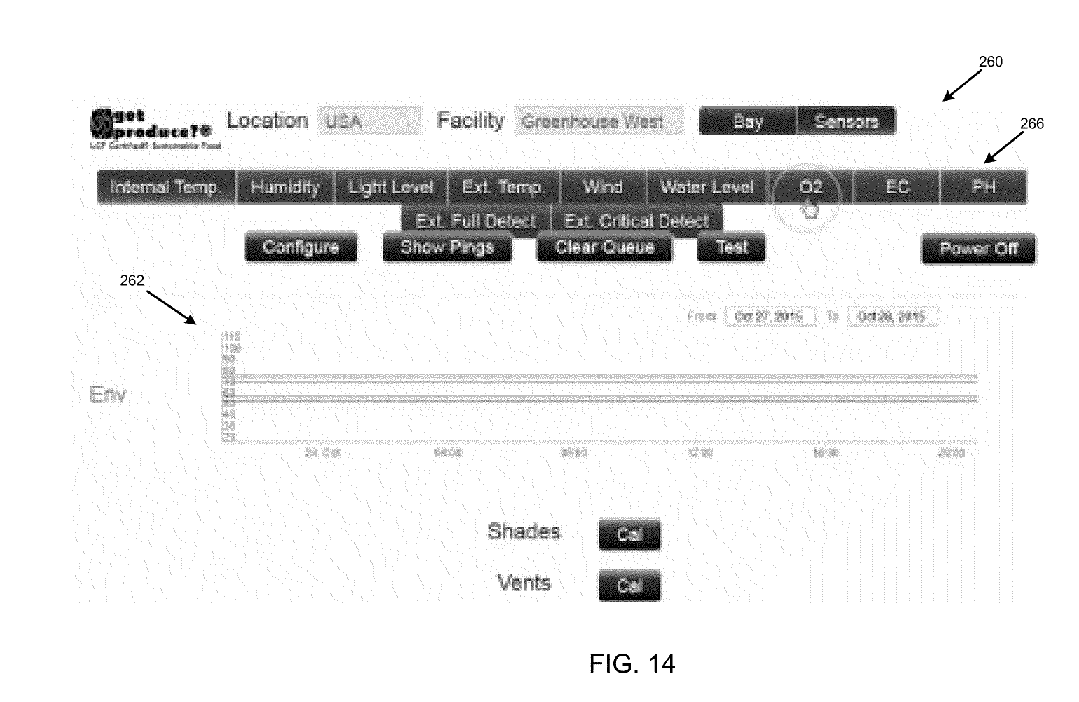

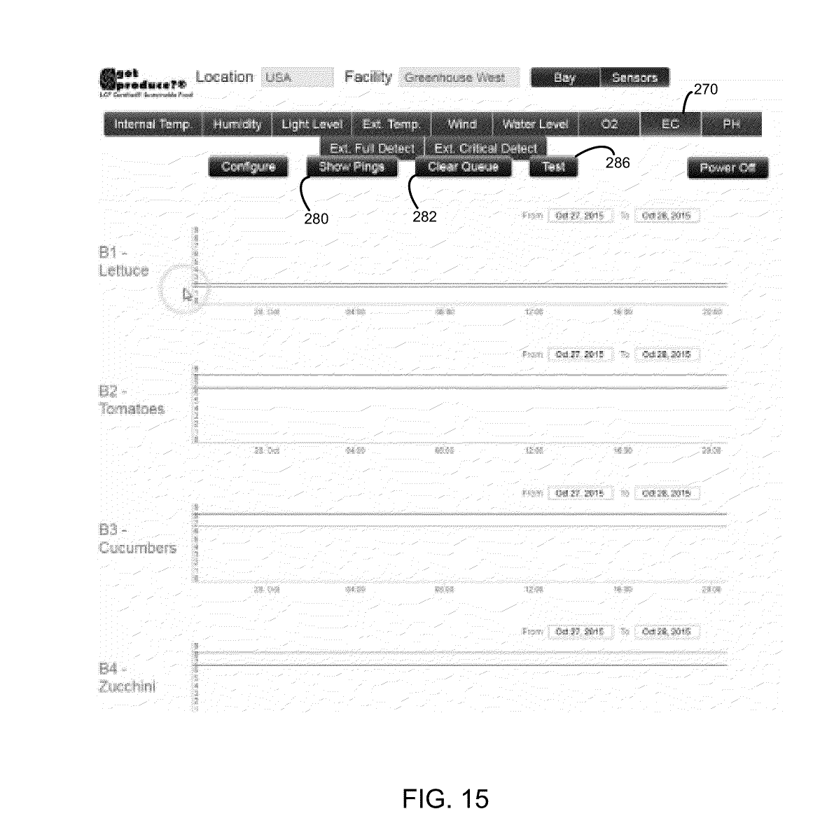

Turning back to FIG. 8, the user interface 190 is showing data from greenhouse environmental sensors because a “Bay” button 250 has been selected. If, however, the user selects a “Sensors” button 252, then the user is presented a sensors view 260 of FIG. 14, which is showing a line graph 262 of internal temperature data, as identified by another upper bar 266 of buttons. To view data from sensors identified by the upper bar 266, the expert may click a corresponding “Sensors” button. For example, FIG. 15 shows that the expert has clicked an “EC” button 270 and is presented with EC data of the bays having EC readings. Although FIG. 15 is cropped, the greenhouse has EC data for all of its eight bays such that the expert can see individual EC readings for each bay. In contrast, the expert can view the bay-style layout to view all of the sensor readings associated with a particular bay. In other words, the two main user interface layouts are a bay configuration layout and a sensor configuration layout.

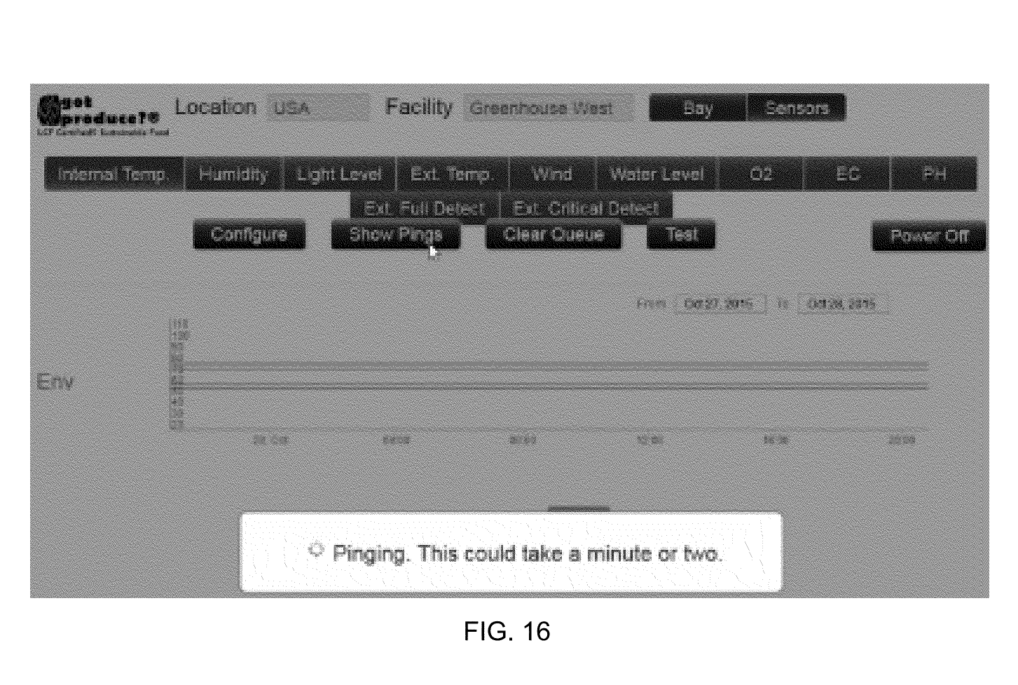

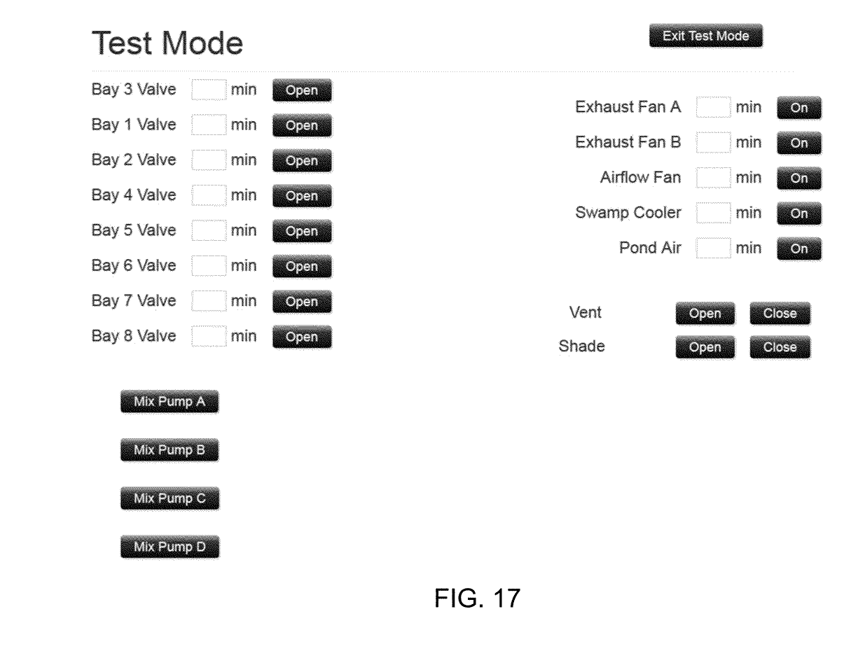

The black buttons are common to each layout, and the black “Configure” button has been previously described. Another black button is a “Show Pings” button 280 that may be clicked to ping all the equipment and test whether it is responding to network-generated pings (as shown in FIG. 16). A “Clear Queue” button 282 can be pressed to clear any of the irrigation trigger (FIFO) queues. And a “Test” button 286 is used to test equipment on-site. For example, the expert or greenhouse operator might walk around the greenhouse with a smart device (e.g., smartphone or iPad®) to test (as shown in FIG. 17) opening and closing of different bay-irrigation and mix tank pump valves as well as activating and deactivating environmental peripheral components.

Turning back to FIG. 7, a recipe for growth has set parameters including heating, cooling, relative humidity, wind speed, and shading. Also, as described previously, the irrigation and fertilization portion of the recipe may be established according to a process 300 performed via a webpage form of the user interface. For example, FIG. 7 shows that an expert selects 302 a “Mix” button to add 304 or edit 306 a mixture. Adding a mixture is initiated by selecting 308 an add (“+”) button and editing a mixture is initiated by selecting 310 a recipe to edit. Recipe parameters can be added or edited 312 in a dialog box, which may be saved by selecting 316 an “OK” button.

Once a recipe is developed according to a process 300 performed via a webpage form of the user interface, the central server 18 then attempts to connect directly to the main controller 20 and update 320 the recipe data stored by the main controller 20. The main controller 20 then performs a handshaking routine in which the main controller 20 requests that the slave database on the central server 18 refresh so that it matches the master database. If the updated recipe has been successfully installed on the main controller 20, the expert will then observe that the updates are present on the user interface served by the central server 18. If the updated recipe has not been successfully installed, the expert will see that their updates have been overwritten on the central server 18. In other words, the central server 18 effectively attempts to push data to the main controller 20, and then backs up whatever data is held by the main controller 20.

The right side of FIG. 7 shows another example technique 172 for assigning recipes to crops. In this example, an onsite grower uses a local computer to log into 330 a main controller webpage or other software interface. For example, the interface may generally correspond to the one shown in FIGS. 8-17. In some other embodiments, however, certain control features may be suppressed to limit a local grower's control of the greenhouse and thereby reduce the risk of an inadvertent configuration that damages crops. Once logged in, the interface displays 336 greenhouse data. The grower can select 338 a configure menu to cause the interface to show a crop configuration tool 342. Then, the grower selects 346 a bay to configure, assigns a preprogrammed recipe 348, and optionally continues assigning 350 recipes. The crop configuration is completed once the grower selects 352 an “OK” button.

According to an embodiment of the watchdog (or tether) timer, the main controller 20 will initiate communication with the central server 18 every eight hours starting at midnight. Upon a successful connection, the central server 18 resets the main controller's 20 tether timer. If more than seven days lapse without a reset of the tether timer, then the main controller 20 will generate an alarm or notification for the greenhouse office 22 (e.g., on tablet 108), halt all further control of peripheral devices, and attempt to connect to the central server 18 every 30 seconds.

In the event of a prolonged outage, an encrypted code is stored in the main controller 20 and the central server 18. The code is available in case a WAN outage occurs and additional time is needed to address the outage. In some embodiments, 20 encrypted codes are auto-generated and refreshed every three months.

The tether timer provides for at least three features. First, it allows the main controller 20 to drop its connection to the central server 18 for several days, but the main controller 20 may still continue to maintain the environment of the greenhouse 12 during this period. Second, it ensures that main greenhouse controllers routinely check in to the central server 18 so that their data can be obtained and closely monitored by greenhouse experts. Third, it provides the centralized experts an ability to shut down greenhouses of operators that are in breach of agreements to properly use and pay for services and equipment provided by hydroponics experts.

Skilled persons will understand that many changes may be made to the details of the above-described embodiments without departing from the underlying principles of the invention. The scope of the present invention should, therefore, be determined only by the following claims.

1. A greenhouse for hydroponically growing multiple types of crops, the greenhouse comprising:
a nutrient mixing system including multiple nutrient containers, each of the multiple nutrient containers being configured to vary a flow rate of nutrients so as to tailor a dosage of nutrients provided in a fertigation solution for delivery to crops, the nutrient mixing system being controllable to provide a first dosage of nutrients according to a first preprogrammed recipe and to provide a second dosage of nutrients according to a second preprogrammed recipe, the first dosage of nutrients being predetermined to facilitate growth of a first crop and having nutrient concentrations provided by the multiple nutrient containers that are different from those of the second dosage of nutrients predetermined to facilitate growth of a second crop that is different than the first crop;
a fertigation system in fluid communication with the multiple nutrient containers of the nutrient mixing system, the fertigation system including a first fertigation zone and a second fertigation zone spaced apart from the first fertigation zone, the first fertigation zone configured to hydroponically grow the first crop by delivering to it, in response to a first irrigation trigger event defined by the first preprogrammed recipe, the fertigation solution adjusted by the nutrient mixing system to have the first dosage of nutrients, the second fertigation zone configured to hydroponically grow the second crop by delivering to it, in response to a second irrigation trigger event defined by and independent of the second preprogrammed recipe, the fertigation solution adjusted by the nutrient mixing system to have the second combination of nutrients; and
a main greenhouse controller configured to detect irrigation trigger events and cause the nutrient mixing system and the fertigation system to deliver the fertigation solution having its dosage tailored for a corresponding one of the first or second crop.

2. The greenhouse of claim 1, in which the multiple nutrient containers comprise nutrient mixture tanks.

3. The greenhouse of claim 1, in which the main greenhouse controller includes network connection circuitry, the network connection circuitry configuring the main greenhouse controller to receive through a wide area network connection the first and second preprogrammed recipes.

4. The greenhouse of claim 1, in which the main greenhouse controller includes network connection circuitry, the network connection circuitry configuring the main greenhouse controller to receive through a local area network connection information associating the first crop with the first fertigation zone and the second crop with the second fertigation zone.

5. The greenhouse of claim 1, in which the first preprogrammed recipe defines the first irrigation trigger event as a predetermined threshold value of sunlight energy reaching the first crop.

6. The greenhouse of claim 1, in which the second preprogrammed recipe defines the second irrigation trigger event as a predetermined period between applications of the fertigation solution to the second crop.

7. The greenhouse of claim 1, in which the multiple nutrient containers comprise a pH additive container and an amino acid container.

8. The greenhouse of claim 7, further comprising a pond system comprising:
a tank configured to hold a water volume that provides a water depth greater than 24 inches;
an oxygen sensor adapted to measure an oxygen concentration of the water volume;
an oxygen dispensing system having a tube disposed within the water volume;
a pH sensor adapted to measure a pH level of the water volume;
a salinity sensor adapted to measure a salinity of the water volume; and
pond sensor and control circuitry configured to:
receive sensor information from the oxygen sensor, the pH sensor, and salinity sensor;
provide through a local area network the sensor information to the main greenhouse controller;
receive through the local area network control instructions from the main greenhouse controller; and
activate, in response to the control instructions, one or more of the oxygen dispensing system, the pH additive container to adjust the pH level of the water volume, or the amino acid container to adjust the salinity of the water volume.

9. The greenhouse of claim 1, in which dosages specified by preprogrammed recipes are specified in terms of a constant volume of nutrients per unit time.

10. The greenhouse of claim 1, in which dosages specified by preprogrammed recipes are specified in terms of a total volume of nutrients for a duration of a dosage cycle.

11. The greenhouse of claim 10, in which a preprogrammed recipe specifies that the total volume of nutrients is to be delivered at a constant average rate for the duration of the dosage cycle.

12. The greenhouse of claim 10, in which a preprogrammed recipe specifies that the total volume of nutrients is to be delivered at a decreasing rate over the duration of the dosage cycle.

13. The greenhouse of claim 1, further comprising a pump head for each of the multiple nutrient containers, and in which dosages specified by preprogrammed recipes are specified based on a number of revolutions of a pump head for each of the multiple nutrient containers.

14. The greenhouse of claim 1, further comprising a pump head for each of the multiple nutrient containers, and in which dosages specified by preprogrammed recipes are controlled by independently setting a variable flow rate of each pump head for a duration specified in a corresponding recipe.

15. The greenhouse of claim 1, in which the main greenhouse controller is configured to stop delivery of the fertigation solution based on an irrigation duration specified in a recipe.

16. The greenhouse of claim 15, in which an EC level and a pH level of the fertigation solution are checked prior to application of the fertigation solution, and the recipe is configured to provide desired EC and pH levels in an absence of further checking during delivery of the fertigation solution.
